(19) United States
(12) Patent Application Publication
(10) Pub. No.: US 2008/0305802 A1
(43) Pub. Date: Dec. 11, 2008

(54) SYSTEM AND METHOD FOR AUGMENTING WIRELESS COVERAGE FOR COMMUNICATION DEVICES

(75) Inventors: BRUCE BARNES, CRYSTAL LAKE, IL (US); SHADI KHOSHABA, SKOKIE, IL (US); JOHN S. PAPAY, NORTH ROYALTON, OH (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/758,505

(22) Filed: Jun. 5, 2007

(51) Int. Cl. H04Q 7/20

(52) U.S. Cl. 455/445

(57) ABSTRACT

A system and method for augmenting wireless coverage for communication devices is disclosed. A system that incorporates teachings of the present disclosure may include, for example, a set-top box (STB) having a multimedia subsystem, a cellular transceiver, and a controller element. The controller element can be used to manage the operation of the multimedia subsystem and the cellular transceiver, wirelessly detect a cellular communication device in a vicinity of the cellular transceiver, and provide the cellular communication device access to one or more cellular networks using the cellular transceiver and an exterior antenna coupled to the STB. Additional embodiments are disclosed.

### FIELD OF THE DISCLOSURE

The present disclosure relates generally to communication systems and more specifically to a system and method for augmenting wireless coverage for communication devices.

### BACKGROUND

Depending on construction materials used and the structural design of a building cellular communications can be poor for cellular subscribers roaming in the building. Some systems have attempted to resolve in-building penetration issues by installing cellular repeater systems. As part of the installation process of a cellular repeater system, a consumer can be asked to test locations in the building to locate optimal cellular coverage with an access unit, wire the access unit to a coverage unit for expanding cellular coverage in the building, and mount said units in the locations identified by the coverage tests. To some consumers the installation process is complicated and undesirable. Additionally, the location chosen to mount these devices may be unattractive.

A need therefore arises for a system and method for augmenting wireless coverage for communication devices.

### BRIEF DESCRIPTION OF THE DRAWINGS

FIG. 1 depicts an exemplary embodiment of a communications system;

FIG. 2 depicts an exemplary embodiment of a Set-top box (STB) in the communications system;

FIG. 3 depicts an exemplary method operating in portions of the communications system; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and method for augmenting wireless coverage for communication devices.

In a first embodiment of the present disclosure, a computer-readable storage medium in a set-top box (STB)can have computer instructions for detecting a cellular communication device in a vicinity of a cellular transceiver embedded in the STB, transmitting outbound cellular signals of said cellular communication device to a cellular network using an exterior antenna coupled to said STB by a coaxial cable, receiving inbound cellular signals of said cellular network for said cellular communication device using the exterior antenna coupled to the STB by the coaxial cable, transmitting the inbound cellular signals from the STB to said cellular communication device using said cellular transceiver, receiving multimedia content at the cellular transceiver of the STB from said cellular communication device, and storing said multimedia content in a memory of the STB using a multimedia subsystem of said STB.

In a second embodiment of the present disclosure, a set-top box (STB) can have a multimedia subsystem, a cellular transceiver, and a controller element to manage the operation of the multimedia subsystem and the cellular transceiver, wirelessly detect a cellular communication device in a vicinity of the cellular transceiver, and provide the cellular communication device access to one or more cellular networks using the cellular transceiver and an exterior antenna coupled to the STB.

In a third embodiment of the present disclosure, a cellular communication device can have a controller element to receive media content signals from a set-top box (STB) having an integrated cellular transceiver.

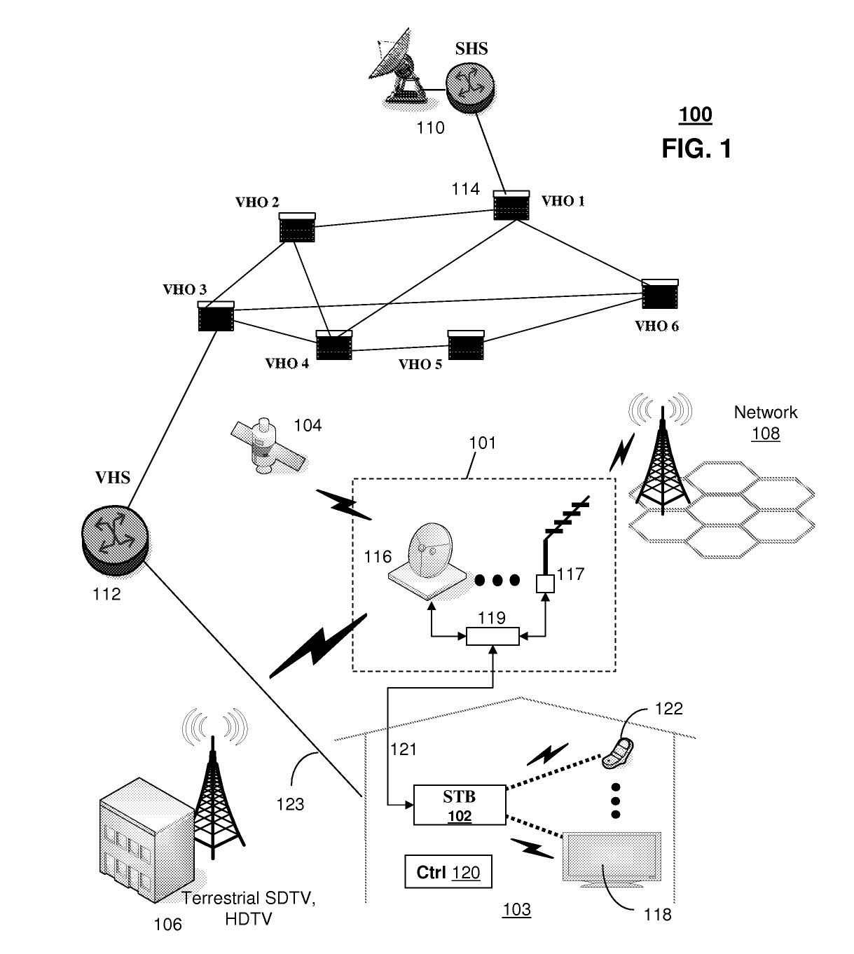

FIG. 1 depicts an exemplary embodiment of a system 100 having portions that can be configured for managing and presenting media content from one or more wireline or wireless media content providers received via a direct link 123 (e.g., fiber, coax cable, twisted pair wires, etc.) or an antenna system or assembly 101 for a structure or building 103, and transmitted to one or more set-top boxes (STBs) 102. In one embodiment, the antenna system 101 can be mounted to an exterior of the structure 103.

For example, digital television (DT) satellites 104 can be a part of a digital satellite television (DST) backbone for delivering media content. In one embodiment, the exterior antenna system 101 can have at least one low-noise block converter (LNB) 116 that distributes satellite broadcast signals to receivers, such as STBs 102. The STBs 102 in turn can present broadcast selections on media devices 118 such as display systems (e.g., computers, LCD or CRT monitors, and LCD or CRT televisions) or audio systems managed in some instances by a wired or wireless media controller 120 (e.g., infrared or RF remote controls). The present disclosure contemplates the use of other components and/or techniques for managing the received signals, including filters and amplifiers.

Alternatively, the STB 102 can receive multimedia broadcast channels from an Internet Protocol TV (IPTV) system coupled by cable to the building 103. A super head office server (SHS) 110 can forward the media content to video head servers (VHS) 112 via a network of video head offices (VHO) 114 according to a common multicast communication method. The VHS 112 can then distributes multimedia broadcast programs to commercial and/or residential buildings 103 by cable. Unicast traffic can also be exchanged between the STBs 102 and the subsystems of the IPTV system for services such as video-on-demand (VoD).

The aforementioned DST system can also be combined or used in combination with terrestrial broadcast distribution systems to deliver television programming to STBs 102 within the structure 103 using wireless access technologies such as WiMAX. Although not shown, terrestrial broadcast systems can deliver content directly to the DST backbone, which in turn delivers the content via satellite 104 to the STBs 102. Alternatively or in combination therewith, a local broadcaster 106 can transmit local broadcast signals using any one of multiple local broadcast protocols. Such local broadcasts can be received by an element of the antenna system 101 configured to receive the local broadcasts, and the received signal can be distributed to the one or more STBs 102. For example, local broadcasters 106 transmitting television signals can encode their signals using NTSC, PAL or SECAM analog encoding protocols, ATSC, DVB-T, or ISDB-T digital encoding protocols, or next generation technologies as they arise. The local broadcasters 106 can modulate this signal onto a carrier wave to deliver standard definition (SDTV), high definition (HDTV) television broadcasts, or next generation broadcasts. However, the communications system 100 is not limited to the reception of television broadcasts, and the antenna system 101 can include multiple antenna elements to support other types of wireless communication technologies, including audio and data communications.

In the illustrated system, the signals received from the multiple antennas of the antenna system 101 can be combined into a single antenna line (e.g., a coaxial line), such as through use of an exterior diplexer unit 119. The antenna system 101 can be mounted at any point on the exterior of the structure 103. For example, the antenna system 101 can be mounted at an elevated point to enhance reception. In some instances, the multiple antenna elements of the antenna system 101 can include powered antenna elements, passive antenna elements, or any combination thereof. In some instances, a power supply can be directly provided at the antenna system 101 to power the powered antenna elements. However, the STB 102 can be configured to provide the necessary power via a coaxial antenna line, using techniques commonly used for providing power to LNBs of a DST system. For example, the power signal from the STB 102 can be configured to provide power to not only an LNB 116 of a satellite antenna element of the antenna system 101, but, as illustrated in FIG. 1, can also be used to power additional antenna elements. Such additional antenna elements can include terrestrial broadcast antenna elements and wireless communications antenna elements 117.

Wireless antenna elements can comprise directional or omni-directional antenna elements to enable communications between wireless communication devices 122 and wireless networks 108, such as cellular, SDR and/or WiMax networks. For example, a powered cellular antenna element 117 can be used to facilitate communications between a cellular network 108 and a cellular communication device 122 located with the structure 103. Furthermore, such a cellular antenna element 117 can comprise a directional antenna pointed at a nearby cell tower to further enhance reception.

Wireless communication devices, such as cellular communication devices 122, can represent a multimode wireless communication device such as a cell phone, laptop computer or personal digital assistant capable of supporting wireline and/or wireless communication technologies. In the case of wireline communications, the wireless communication device 122 can utilize xDSL, cable, or PSTN telephony interfaces for communicating with networks which can include hybrid technologies that support circuit-switched packet-switched communications. The portable communication device 122 can also support accessory interfaces such as USB, Firewire, and other connectivity technologies.

A wireless communication device 122 can support any number of wireless communication protocols such as the family of 802 protocols defined by the Institute of Electrical and Electronics Engineers (IEEE). For instance, the wireless communication device 122 can utilize long-range wireless access technologies such as, for example, cellular, software defined radio (SDR) and/or WiMAX to communicate with one or more networks 108. Cellular access technologies can include, for example, CDMA-1X, UMTS/HSDPA, GSM/GPRS, TDMA/EDGE, EV/DO, and next generation technologies as they arise. Additionally, a wireless or cellular communication device 122 can support short-range wireless technologies such as WiFi, Bluetooth, Zigbee, or cordless communications such as digital enhanced cordless telecommunications (DECT). Furthermore, a wireless communication device 122 can access one or more online systems through the cellular network 108. Online systems can correspond to one or more web servers operating as centralized or distributed computing systems for purposes of delivering multimedia content to wireless communication devices 122.

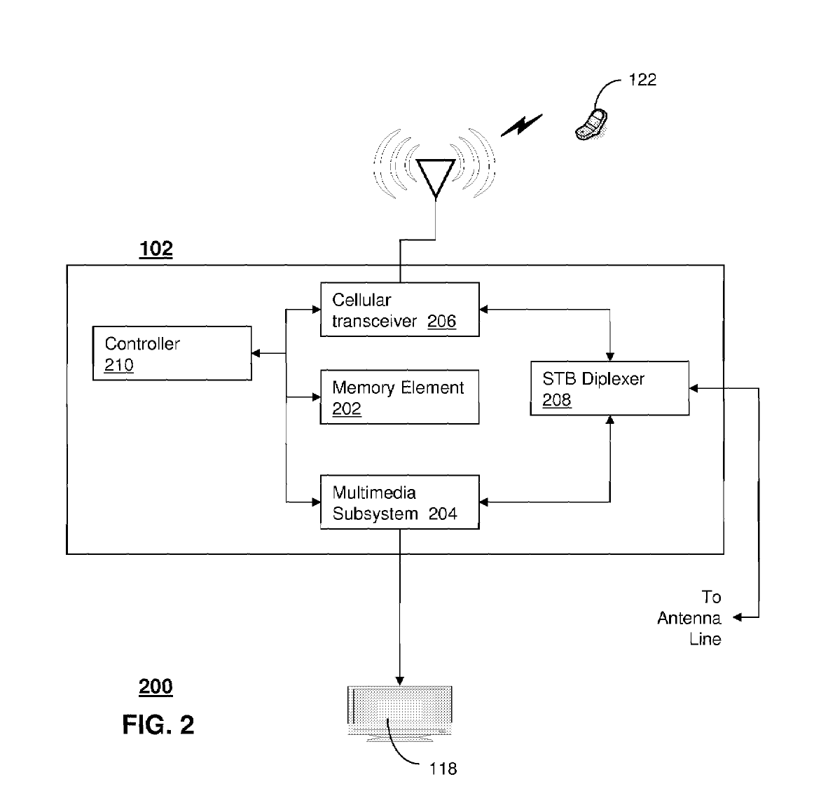

FIG. 2 depicts an STB 102 that can operate in the communications system 100. The STB 102 can comprise a memory element 202, a multimedia subsystem 204, a cellular transceiver 206, a diplexer element 208, and a controller element 210 to manage operations thereof. The components of STB 102 can be a single, integrated device or can be a system of components coupled to each other, such as a modular STB. The memory element 202 can utilize common storage technologies (e.g., hard disk drives, flash memory, etc.) for retrieval and storage of audio media, moving image media, and still image media received from one or more local or remote locations. The multimedia subsystem 204 can utilize common audio, visual, and video processing technologies (e.g., Moving Pictures Experts Group (MPEG), Joint Photographics Experts Group (JPEG), Graphic Interchange Format (GIF), H.264, high definition TV, standard definition TV, etc.) to manage and present media on the media device 118. The cellular transceiver 206 can utilize common cellular access technologies, such as CDMA-1X, UMTS/HSDPA, GSM/GPRS, TDMA/EDGE, EV/DO, and other technologies supported by the wireless or cellular networks, to communicate with one or more wireless communication devices 122. The diplexer element 208 can be used to divide inbound signals and combine outbound signals of the cellular transceiver 206 and the multimedia subsystem 204 for transmission over a common coaxial antenna line 121 coupled to the exterior antenna system 101. The present disclosure contemplates the use of other components for dividing and combining the signals with respect to transmission over the antenna line 121, including separate combiner and splitter components, as well as duplexers.

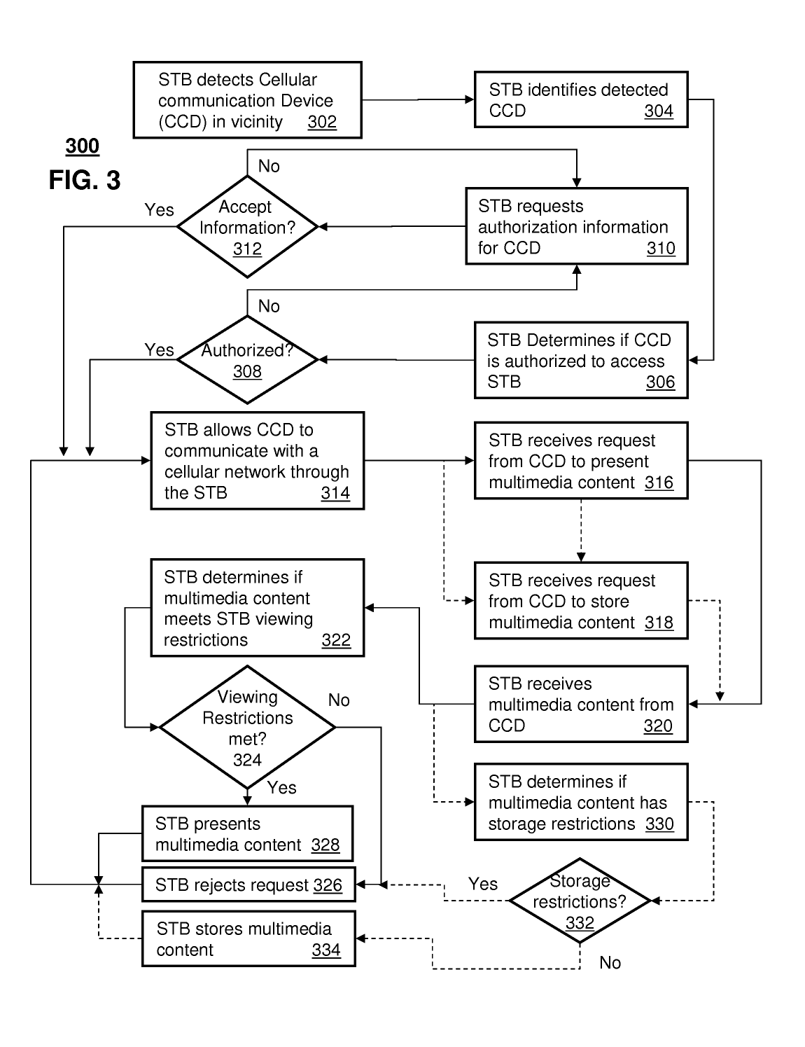

FIG. 3 depicts an exemplary method 300 operating in portions of the system 100. Method 300 has variants as depicted by the dashed lines and is described with reference also to FIGS. 1 and 2. It would be apparent to an artisan with ordinary skill in the art that other embodiments not depicted in FIG. 3 are possible without departing from the scope of the claims described below.

Method 300 can begin with the STB 102 in step 302 detecting a wireless or a cellular communication device (CCD) 122 in the vicinity of the STB 102 via the cellular transceiver 206. Such detection can occur in several ways. In general, CCDs 122, such as a cellular phones, can be configured to automatically connect to the strongest cellular tower signal available. Therefore, an exemplary detection method can be based on this principle. In a first example, the STB 102 can be configured to detect a CCD 122 passively. That is, the STB 102 waits for a CCD 122 to contact the STB 102. In this example, the STB 102 can be configured, by default, to provide a relatively strong signal from the cellular transceiver 206 within the structure 103 and a CCD 122 would attempt to connect to the STB 102 first and attempt to connect to weaker external sources second. Consequently, the signals transmitted to the STB 102 by the CCD 122 during the connection attempt can be used as a detection signal for the STB 102. In a second example, the STB 102 can be configured to detect a CCD 122 actively. In this example, the cellular transceiver 206 can be configured to not generate any signals by default. Instead, the STB 102 can use the cellular transceiver 206 to actively monitor for any radio signals being generated by CCDs 122. In response to detecting such signals, the STB 102 can then increase the signal strength of the cellular transceiver 206 and trigger the CCD 122 to switch over from a local cellular tower to the cellular transceiver 206.

In response to detecting the CCD 122 in step 302, the STB 102 in step 304 can communicate with the detected CCD 122 and retrieve identifier information for the detected CCD 122. For example, the CCD 122 can forward a telephone number or other CCD 122 identifying information, such as ESN, IMEI, or MEID information, to the STB 102. The STB 102 in step 306 can then determine, based on the retrieved information, whether the detected CCD 122 is authorized to communicate with the STB 102. For example, the STB 102 can access a local or remote memory element 202 of the STB 102 and compare the information retrieved with a list of registered CCD's 122 authorized to access the STB 102. If the CCD 122 is determined by the STB 102 to be authorized in step 308, the STB 102 can allow the CCD 122 to connect via the cellular transceiver 206 and the STB 102 can connect to one or more cellular networks 108 via the antenna system 101.

However, if the STB 102 determines that the CCD 122 is not authorized to access the STB 102, the STB 102 in step 310 can request a user to enter authorization information to allow access. This step can be used in cases where end users would like to restrict CCD 122 access to an STB 102 on a per user basis. The authorization information can be a user ID, a password, a personal identification number (PIN), a biometric ID (e.g., voice, fingerprint, retina, etc.) or other suitable form of identification. In some instances, the authorization information can be entered via the STB 102, the media device 118, or a media controller 120. In other instances, the STB 102 can be configured to communicate with the CCD 122 directly and prompt a user to enter authorization information via the user interface of the CCD 122.

If the authorization information received by the STB 102 is valid, then the STB 102 can proceed to steps 314 where it allows the CCD 122 to connect to a wireless network 108 via the cellular transceiver 206 coupled to the antenna system 101. The CCD 122 can also be registered with the STB 102 to facilitate future access. If the entry is invalid in step 312, the STB 102 can reject the authorization information and return to step 310. Additionally, the STB 102 can be further programmed to reject additional authorization attempts after several consecutive authorization failures. The STB 102 can, for example, reject further attempts for a period of time to reduce the possibility of an unauthorized user guessing the authorization information. The STB 102 can also be programmed to submit a notice of possible tampering to its end user by way of, for example, an email, or over-the-air message.

Once the authorized CCD 122 has access to the cellular network 108, the CCD 122 in step 314 can communicate with the cellular networks and receive multimedia content from a content provider connected to the cellular network. However, in method 300, the STB 102 is not only configured to provide CCD's access to cellular networks, but the STB 102 can also be cooperatively used with the CCD 122 to present multimedia content being received by the CCD 122. For example, the cellular transceiver 206 can be utilized by the STB 102 to exchange information between the CCD 122 and the multimedia subsystem 204 or the memory element 202 of the STB 102. Such a configuration can allow at least some multimedia content to be more easily presented and utilized by the user via the STB 102.

Such content can include any type of multimedia presentation including audio, visual, or audio/visual presentations. For example, the multimedia content can comprise an audio-only program such as a voice or music program, a visual-only program such as a video bulletin board or a collection of still pictures from a picture album or textual information, or an audio/visual program such as a movie or television program. Alternatively or in combination therewith, such multimedia content can be included as part of a received voice message or as part of an SMS or MMS text message.

For example, in method 300 the STB 102 can present content received by a CCD 122 during an ongoing call. Such content received during a call can include the video portion of a videoconference call or picture or video messages sent during a call. However, the STB 102 in method 300 can be additionally configured to present content previously received, accessible, or stored in the CCD 122. Such content can include, for example, content from multimedia content providers accessible via the cellular network. Additionally, as previously noted, the content can include voice messages, SMS messages, or MMS messages.

The STB 102 in step 316 can receive a request from the CCD 122 to present multimedia content. The request can be received by the STB 102 in several ways. In some instances, the request might be sent automatically to the STB 102 in response to certain types of events. For example, if a cell phone user receives a videoconference call, the CCD 122 can be configured to request the STB 102 to present the video portion of the call automatically. Similarly, a request can be automatically generated when a picture and/or a video message is received during a call. In another example, when a user plays back multimedia content stored on a CCD 122 that is connected via the STB 102 to a cellular network, the CCD 122 can be configured to also automatically request the STB to present the multimedia content. However, in other instances the CCD 122 can be configured to send a request to the STB 102 only upon a user request. For example, in the case of the videoconference call, the CCD 122 can be configured to provide a user with the option to route video information to the STB 102. Similarly, the CCD 122 can prompt the user to request the STB 102 to present multimedia content upon selection.

In one embodiment, alternatively, or in combination with step 316, the STB 102 in step 318 can also receive a request from the CCD 122 to store multimedia content in a memory element 202 of the STB 102. For example, an STB 102 configured as a digital video recorder (DVR) could receive a request from a CCD 122 to store video content received as an additional DVR recording. Similarly, the STB 102 can be configured to receive a request to store audio content, such as voice messages or music stored on the CCD 122.

Once the request is received by the STB 102 in steps 316 and/or 318, the STB 102 in step 320 can begin to receive the multimedia content from the CCD 122. However, in method 300, prior to presenting or storing the multimedia content, the STB 102 can determine whether any restrictions exist for presenting or storing the multimedia content.

For example, the STB 102 in step 322, upon receiving and reviewing the multimedia content to present from the CCD 122, can determine whether any viewing restrictions for the content exist. For example, the STB 102 can be configured to only present content meeting a certain rating or age restrictions. In such instances, multimedia content which does not meet the age or rating restriction would not be presented on the media device 118 by the STB 102. Such a configuration can allow parental controls on the STB 102 to be used for any type of content that is presented through the STB 102. In another example, the multimedia content can have one or more viewing restrictions under copyright law. In such instances, the license agreement for the multimedia content may limit the content to be presented only on the CCD 122. Thus, the digital license associated with the multimedia content can prevent its presentation via the STB 102.

If such viewing restrictions exist in step 324, the STB 102 in step 326 can reject the request and does not present the multimedia content. However, if no viewing restrictions exist or the multimedia content meets the viewing restrictions in step 324, the STB 102 in step 328 can present the multimedia content on a connected media device 118.

In one embodiment, alternatively, or in combination with steps 322-328, the STB 102 can also determine whether storage restrictions for the multimedia content exist, as in step 330. For example, the STB 102 can be configured to only store content meeting a certain rating or age restrictions. In such instances, multimedia content which does not meet these age or rating restriction would not be stored. Such a configuration can allow parental controls on the STB 102 to extend to any type of content that is to be stored in the STB. In another example, the multimedia content can have one or more storage or copying restrictions under copyright law. In such instances, the digital license for the multimedia content may prevent the content to be stored in a location other than on the CCD 122.

If in step 332 it is determined that such storage restrictions exist, then the STB 102 can reject the request and would not store the multimedia content, as back in step 326. However, if no storage restrictions exist or the storage restrictions permit the multimedia to be stored in the STB 102, the STB 102 in step 334 can store the multimedia content. The stored content can then be accessed at a later time by the STB 102 user. For example, the content can be stored, as previously discussed, as additional entries in a listing of recordings in a DVR menu of an STB 102.

Once the request is processed by the STB 102, the method 300 can repeat steps 314-334 by allowing the CCD 122 to continue to receive multimedia content through the cellular transceiver 206 of the STB 102 and processing requests from the CCD 122 to store and/or present the received multimedia content on one or more media devices 118 coupled to the STB 102.

Upon reviewing the aforementioned embodiments, it would be evident to an artisan with ordinary skill in the art that said embodiments can be modified, reduced, or enhanced without departing from the scope and spirit of the claims described below. For example, STB 102 can allow any CCD 122 to access one or more cellular networks via the wireless transceiver, but only allow authorized CCD's 122 to present or store multimedia content in the STB 102. In another example, registered CCD 122 information for the STB 102 can be generated by entering authorized CCD 122 information via an interface of the STB 102 or via a web application connected to a server of the DST backbone, which in turn can forward the information to the memory element 202 of STB 102. In yet another example, the DST backbone can have at least one server configured to forward an authentication code to at least one CCD 122, where upon connecting to the cellular transceiver 206 of the STB 102, the CCD 122 can be configured to automatically transmit the authorization code to the STB 102, allowing access. Various configurations of STBs 102 and media devices 118 can be utilized in the structure 103. For example, a CCD 122 can be in communication with a plurality of STBs 102 that can store and/or present the media content. In one embodiment, the CCD 122 can select which of the STBs 102 for storage and/or which of the media devices 118 for presentation, such as through a listing presented on a display of the CCD.

These are but a few examples of modifications that can be applied to the present disclosure without departing from the scope of the claims stated below. Accordingly, the reader is directed to the claims section for a fuller understanding of the breadth and scope of the present disclosure.

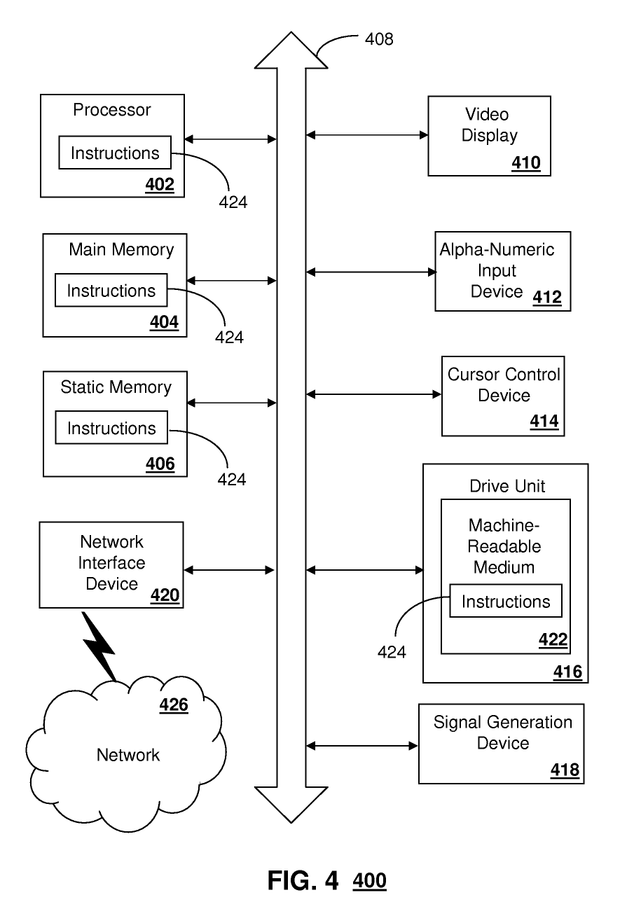

FIG. 4 depicts an exemplary diagrammatic representation of a machine in the form of a computer system 400 within which a set of instructions, when executed, can cause the machine to perform any one or more of the methodologies discussed above. In some embodiments, the machine operates as a standalone device. In some embodiments, the machine can be connected (e.g., using a network) to other machines. In a networked deployment, the machine can operate in the capacity of a server or a client user machine in server-client user network environment, or as a peer machine in a peer-to-peer (or distributed) network environment.

The machine can comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 can include a processor 402 (e.g., a central processing unit (CPU), a graphics processing unit (GPU, or both), a main memory 404 and a static memory 406, which communicate with each other via a bus 408. The computer system 400 can further include a video display unit 410 (e.g., a liquid crystal display or LCD), a flat panel, a solid state display, or a cathode ray tube (CRT)). The computer system 400 can include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 can include a machine-readable medium 422 on which is stored one or more sets of instructions (e.g., software 424) embodying any one or more of the methodologies or functions described herein, including those methods illustrated above. The instructions 424 can also reside, completely or at least partially, within the main memory 404, the static memory 406, and/or within the processor 402 during execution thereof by the computer system 400. The main memory 404 and the processor 402 also can constitute machine-readable media.

Dedicated hardware implementations including, but not limited to, application specific integrated circuits, programmable logic arrays and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 can further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments can be utilized and derived therefrom, such that structural and logical substitutions and changes can be made without departing from the scope of this disclosure. Figures are also merely representational and can not be drawn to scale. Certain proportions thereof may be exaggerated, while others may be minimized. Accordingly, the specification and drawings are to be regarded in an illustrative rather than a restrictive sense.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a set-top box (STB), comprising computer instructions for:
detecting a cellular communication device in a vicinity of a cellular transceiver embedded in the STB;
transmitting outbound cellular signals of said cellular communication device to a cellular network using an exterior antenna coupled to said STB by a coaxial cable;
receiving inbound cellular signals of said cellular network for said cellular communication device using the exterior antenna coupled to the STB by the coaxial cable;
transmitting the inbound cellular signals from the STB to said cellular communication device using said cellular transceiver;
receiving multimedia content at the cellular transceiver of the STB from said cellular communication device; and
storing said multimedia content in a memory of the STB using a multimedia subsystem of said STB.

2. The storage medium of claim 1, comprising computer instructions for presenting the multimedia content at a media device using the multimedia subsystem.

3. The storage medium of claim 1, wherein the received multimedia content is at least one among a download from a content provider, a text message, a voice message, and a video portion of a video-conferencing call.

4. The storage medium of claim 1, comprising computer instructions for restricting access to the STB by the cellular communication device.

5. The storage medium of claim 4, comprising computer instructions for removing restricted access to the STB upon receiving at least one among a user ID, a password, a personal identification number (PIN), and a biometric identity.

6. The storage medium of claim 1, comprising computer instructions for retrieving guidelines for at least one among presentation of received multimedia content and storage of received multimedia content on the STB.

7. The storage medium of claim 6, wherein the guidelines comprise at least one among an allowable period for presenting the received multimedia content, one or more rating restrictions for presenting the received multimedia content, storage restrictions for the received multimedia content, and an allowable storage period for the received multimedia content.

8. The storage medium of claim 1, wherein the outbound and inbound cellular signals conform to one among a group of cellular protocols comprising global system for mobile communication (GSM), a code division multiple access (CDMA), wide-band CDMA (WCDMA), universal mobile telecommunications system (UMTS), and derivatives thereof.

9. The storage medium of claim 8, wherein the outbound and inbound cellular signals support at least one among voice, video and data services, and wherein the cellular communication device is at least one among a computer, a personal digital assistant, and a cellular network access device.

10. A set-top box (STB) comprising:
a multimedia subsystem;
a cellular transceiver; and
a controller element to:
manage the operation of the multimedia subsystem and the cellular transceiver;
wirelessly detect a cellular communication device in a vicinity of the cellular transceiver; and
provide the cellular communication device access to one or more cellular networks using the cellular transceiver and an exterior antenna coupled to the STB.

11. The STB of claim 10, wherein the controller element configures the multimedia subsystem to present at a media device at least a portion of multimedia content received by the cellular communication device and wherein the presented portion of the received multimedia content is at least one among a download from a content provider, a text message, a voice message, and a video portion of a video-conferencing call.

12. The STB of claim 10, comprising a memory element, wherein the controller element stores at least a portion of the multimedia content received by the cellular communication device in the memory element.

13. The STB of claim 12, wherein the stored portion of the received multimedia content is at least one among a download from a content provider, a text message, and a voice message.

14. The STB of claim 10, comprising a diplexer element coupled to said multimedia subsystem, said cellular transceiver and said exterior antenna.

15. The STB of claim 10, wherein access to the STB by the cellular communication device is restricted.

16. The STB of claim 15, wherein access to the STB by the cellular communication device is allowed upon receiving at least one among a user ID, a password, a personal identification number (PIN), and a biometric identity.

17. The STB of claim 10, wherein a signal from the cellular transceiver conforms to one among a group of cellular protocols comprising global system for mobile communication (GSM), a code division multiple access (CDMA), wide-band CDMA (WCDMA), universal mobile telecommunications system (UMTS), and derivatives thereof.

18. A cellular communication device, comprising a controller element to receive media content signals from a set-top box (STB) having an integrated cellular transceiver.

19. The cellular communication device of claim 18, wherein the integrated cellular transceiver of the STB comprises an antenna coupled to a satellite dish that supplies multimedia services to the STB.

20. The cellular communication device of claim 18, wherein the controller element:
receives multimedia content from the integrated cellular transceiver of the STB; and
transmits said multimedia content to the integrated cellular transceiver of the STB for presentation at a media device coupled to the STB.

21. The cellular communication device of claim 18, wherein the controller element selects the integrated cellular transceiver as a preferred means of communication to a cellular base station, and wherein the integrated cellular transceiver of the STB and the cellular communication device utilize a wireless access technology comprising one among global system for mobile communication (GSM), a code division multiple access (CDMA), wide-band CDMA (WCDMA), universal mobile telecommunications system (UMTS), and derivatives thereof.
